(19) United States
(12) Patent Application Publication
(10) Pub. No.: US 2024/0242167 A1
(43) Pub. Date: Jul. 18, 2024

(54) Systems for Globally Optimal and Locally Specific Classification of Items

(71) Applicant: IGlobal Exports LLC, St. George, UT (US)

(72) Inventor: Jonathan Sullivan, Hurricane, UT (US)

(21) Appl. No.: 18/098,369

(22) Filed: Jan. 18, 2023

(51) Int. Cl. G06Q 10/0831

(52) U.S. Cl. CPC G06Q 10/0831

(57) ABSTRACT

Systems for providing globally optimal and locally specific classification of a plurality of goods using Harmonized System (HS) codes and Harmonized Tariff Schedule (HTS) codes are disclosed. Some embodiments include: maintaining a database of import/export classifications for a plurality of goods comprising Harmonized System codes of the plurality of goods and Harmonized Tariff Schedule codes of the plurality of goods, receiving an import/export classification request from a user for an import/export classification of a good of a cross-border commerce transaction, responding to the import/export classification request by generating a computerized classification result by searching the database of import/export classifications for the plurality of goods using a two phase approach and providing a Harmonized Tariff Schedule code for the good of the cross-border commerce transaction to the user in response to the import/export classification request with increased Coherence and speed.

### FIELD OF THE TECHNOLOGY

Embodiments of the disclosure relate to a tool for generating Harmonized System (HS) codes and Harmonized Tariff Schedule (HTS) codes for globally optimal and locally specific classification of items.

### SUMMARY

In some aspects, the techniques described herein relate to a computer-implemented method for providing classification of a plurality of goods using Harmonized System (HS) codes and Harmonized Tariff Schedule (HTS) codes, including: maintaining a database of import/export classifications for a plurality of goods including Harmonized System (HS) codes of the plurality of goods and Harmonized Tariff Schedule (HTS) codes of the plurality of goods; receiving an import/export classification request from a user for an import/export classification of a good of a cross-border commerce transaction; responding to the import/export classification request by generating a computerized classification result by searching the database of import/export classifications for the plurality of goods using a two phase approach, the two phase approach including: generating, during a first phase, a Harmonized System (HS) code for the good of the cross-border commerce transaction using a global classification model, the global classification model using a bespoke model with a static set of classes; and refining, during a second phase, the Harmonized System (HS) code for the good of the cross-border commerce transaction to generate a Harmonized Tariff Schedule (HTS) code for the good of the cross-border commerce transaction using a locally specific model, the locally specific model using a zero-shot classification with a dynamic set of classes; and providing a Harmonized Tariff Schedule (HTS) code for the good of the cross-border commerce transaction to the user in response to the import/export classification request, the providing having increased Coherence and speed compared to using a full zero-shot classification with a one phase approach.

In some aspects, the techniques described herein relate to a computer-implemented method, wherein the Harmonized System (HS) code is a unique six-digit code of the good of the cross-border commerce transaction.

In some aspects, the techniques described herein relate to a computer-implemented method, wherein the Harmonized Tariff Schedule (HTS) code is an eight-digit code of the good of the cross-border commerce transaction.

In some aspects, the techniques described herein relate to a computer-implemented method, wherein the Harmonized Tariff Schedule (HTS) code is a ten-digit code of the good of the cross-border commerce transaction.

In some aspects, the techniques described herein relate to a computer-implemented method, wherein the Harmonized Tariff Schedule (HTS) code is a twelve-digit code of the good of the cross-border commerce transaction.

In some aspects, the techniques described herein relate to a computer-implemented method, wherein the maintaining the database includes importing labeled classification data from a plurality of counties and training a Harmonized System (HS) classifier using the labeled classification data from the plurality of counties, the Harmonized System (HS) classifier being used for the generating, during the first phase, the Harmonized System (HS) code for the good of the cross-border commerce transaction.

In some aspects, the techniques described herein relate to a computer-implemented method, wherein the maintaining the database further includes storing classified HS Codes using the Harmonized System (HS) classifier.

In some aspects, the techniques described herein relate to a computer-implemented method, wherein the maintaining the database includes importing labeled classification data from a plurality of counties and training a Harmonized Tariff Schedule (HTS) refiner, the Harmonized Tariff Schedule (HTS) refiner being used during the second phase.

In some aspects, the techniques described herein relate to a computer-implemented method, wherein the maintaining the database further includes storing classified HTS codes using the Harmonized Tariff Schedule (HTS) refiner.

In some aspects, the techniques described herein relate to a computer-implemented method, wherein the user is a merchant, an individual, an importer, or an exporter.

In some aspects, the techniques described herein relate to an apparatus for providing classification of a plurality of goods using Harmonized System (HS) codes and Harmonized Tariff Schedule (HTS) codes, including: at least one memory storing computer program instructions; and at least one processor configured to execute the computer program instructions to cause the apparatus at least to: maintain a database of import/export classifications for a plurality of goods including Harmonized System codes of the plurality of goods and Harmonized Tariff Schedule codes of the plurality of goods; receive an import/export classification request from a user for an import/export classification of a good of a cross-border commerce transaction; respond to the import/export classification request by generating a computerized classification result by searching the database of import/export classifications for the plurality of goods using a two phase approach, the two phase approach including: generate, during a first phase, a Harmonized System (HS) code for the good of the cross-border commerce transaction using a global classification model, the global classification model using a bespoke model with a static set of classes; and refine, during a second phase, the Harmonized System (HS) code for the good of the cross-border commerce transaction to generate a Harmonized Tariff Schedule (HTS) code for the good of the cross-border commerce transaction using a locally specific model, the locally specific model using a zero-shot classification with a dynamic set of classes; and provide a Harmonized Tariff Schedule code for the good of the cross-border commerce transaction to the user in response to the import/export classification request, the providing having increased Coherence and speed compared to using a full zero-shot classification with a one phase approach.

In some aspects, the techniques described herein relate to an apparatus, wherein the Harmonized System (HS) code is a unique six-digit code of the good of the cross-border commerce transaction.

In some aspects, the techniques described herein relate to an apparatus, wherein the Harmonized Tariff Schedule (HTS) code is an eight-digit code of the good of the cross-border commerce transaction.

In some aspects, the techniques described herein relate to an apparatus, wherein the Harmonized Tariff Schedule (HTS) code is a ten-digit code of the good of the cross-border commerce transaction.

In some aspects, the techniques described herein relate to an apparatus, wherein the Harmonized Tariff Schedule (HTS) code is a twelve-digit code of the good of the cross-border commerce transaction.

In some aspects, the techniques described herein relate to an apparatus, wherein the maintaining the database includes importing labeled classification data from a plurality of counties and training a Harmonized System (HS) classifier using the labeled classification data from the plurality of counties, the Harmonized System (HS) classifier being used for the generating, during the first phase, the Harmonized System (HS) code for the good of the cross-border commerce transaction.

In some aspects, the techniques described herein relate to an apparatus, wherein the maintaining the database further includes storing classified HS Codes using the Harmonized System (HS) classifier.

In some aspects, the techniques described herein relate to an apparatus, wherein the maintaining the database includes importing labeled classification data from a plurality of counties and training a Harmonized Tariff Schedule (HTS) refiner, the Harmonized Tariff Schedule (HTS) refiner being used during the second phase.

In some aspects, the techniques described herein relate to an apparatus, wherein the maintaining the database further includes storing classified HTS codes using the Harmonized Tariff Schedule (HTS) refiner.

In some aspects, the techniques described herein relate to a system, including: one or more hardware processors configured by machine-readable instructions to: maintain a database of import/export classifications for a plurality of goods including Harmonized System codes of the plurality of goods and Harmonized Tariff Schedule codes of the plurality of goods; receive an import/export classification request from a user for an import/export classification of a good of a cross-border commerce transaction; respond to the import/export classification request by generating a computerized classification result by searching the database of import/export classifications for the plurality of goods using a two phase approach, the two phase approach including: generate, during a first phase, a Harmonized System (HS) code for the good of the cross-border commerce transaction using a global classification model, the global classification model using a bespoke model with a static set of classes; and refine, during a second phase, the Harmonized System (HS) code for the good of the cross-border commerce transaction to generate a Harmonized Tariff Schedule (HTS) code for the good of the cross-border commerce transaction using a locally specific model, the locally specific model using a Natural Language Understanding model with a dynamic set of classes; and provide a Harmonized Tariff Schedule code for the good of the cross-border commerce transaction to the user in response to the import/export classification request, the providing having increased Coherence and speed compared to using a full Natural Language Understanding model with a one phase approach.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

FIG. 1 illustrates a high-level block diagram of an exemplary database system configured for providing globally optimal and locally specific classification of a plurality of goods using Harmonized System (HS) codes and Harmonized Tariff Schedule (HTS) codes, according to various embodiments of the present technology.

FIG. 2 illustrates a system configured for providing globally optimal and locally specific classification of a plurality of goods using Harmonized System (HS) codes and Harmonized Tariff Schedule (HTS) codes, according to various embodiments of the present technology.

FIG. 3 illustrates a method for providing classification of a plurality of goods globally optimal and locally specific using Harmonized System (HS) codes and Harmonized Tariff Schedule (HTS) codes, according to various embodiments of the present technology.

FIG. 4 shows a high-level block diagram of an exemplary computer system for implementing various embodiments of the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices may be shown in block diagram form only in order to avoid obscuring the disclosure. It should be understood that the disclosed embodiments are merely exemplary of the invention, which may be embodied in multiple forms. Those details disclosed herein are not to be interpreted in any form as limiting, but as the basis for the claims.

The Harmonized System (hereinafter “HS”) administered by the World Customs Organization is an international standard taxonomy of item classification recognized by over one-hundred-and-eighty countries. Moreover, over ninety-eight percent of the merchandise in international trade is classified in terms of the HS. The HS is also extensively used by governments, international organizations, and the private sector for many purposes such as internal taxes, monitoring of controlled goods, rules of origin, freight tariffs, and compilation of national accounts. The HS, thus, is a universal economic language using codes for goods, and is an indispensable tool for international trade.

The HS uses codes (hereinafter “HS codes”) that include more than five-thousand commodity groups, comprising unique six-digit codes that are arranged in a legal and logical structure that are supported by well-defined rules to achieve uniform classification. HS codes are six digits that can be broken down into three parts: the first two digits identify the chapter in the HS Nomenclature that the goods are classified in, the next two digits identify the heading within that chapter, and the last two digits identify the subheading within that chapter. In other words, the first two digits designate the HS Chapter, the second two digits designate the HS heading, and the third two digits designate the HS subheading. For example, the HS code for men's golf shoes is classified as 6402.19. The first two digits “64” designate the HS Chapter, “Footwear, gaiters and the like”. The second two digits designate the HS heading “Other footwear with outer soles and uppers of rubber or plastics”. The third two digits designate the HS subheading “Sports footwear with outer soles and uppers of rubber or plastics”.

In addition to the standardized six-digit HS codes, most countries add further levels of taxonomy to classification by using country-specific Harmonized Tariff Schedule codes (hereinafter “HTS codes”) that are eight-digit, ten-digit, or even twelve-digit HTS codes. HTS codes can be broken down into two parts. The first six digits are an HS code (e.g., 6402.19 for men's golf shoes), and specific countries of import assign the subsequent digits to provide additional classification. For example, HTS codes for the United States are ten-digits and are administered by the U.S. International Trade Commission. For example, the ten-digit HTS code for men's golf shoes in the United States is 6402.19.05.30, which is specific to the United States. The standardized six-digit HS code for men's golf shoes is the first six-digits of the HTS code (6402.19.05.30) (emphasis added). The first six digits 6402.19 are the HS code. The last four digits of the HTS code (6402.19.05.30) are the United States-specific portion of the HTS code for “Golf shoes. For Men”. (emphasis added) However, the same product (men's golf shoes) is classified as 6402.19.00.00 in the United Kingdom (emphasis added), with a different county specific four-digit portion of the HTS code.

A problem in this field is that in order to import a good into a country, an importer must provide an item's correct HS code. As is the case with the majority of “e-commerce” packages, the customer is likely to be an end consumer, who is unlikely to possess the knowledge necessary to perform the classification of the good. As such, many merchants maintain a database of HS codes for the items they sell. Updating and maintaining a database of HS codes is burdensome and costly for merchants, especially given the fact that merchants often have customers in many dozens of different countries, with different HTS codes. As such, an HS/HTS classification tool is needed to assist the merchants, importers, or others in the cross-border commerce domain especially for “electronic-commerce”. In order for an HS/HTS classification tool to be successful, the accuracy of the classifications and coverage of each country's specific HTS codes are paramount. In the traditional classification paradigm, these two priorities are competing. A traditional classification model cannot share information across markets to learn the HS codes while at the same time covering all the unique country-specific HTS codes.

The present technology solves this problem and successfully does both by optimizing HS codes for global accuracy and scalable coverage of the country specific HTS codes.

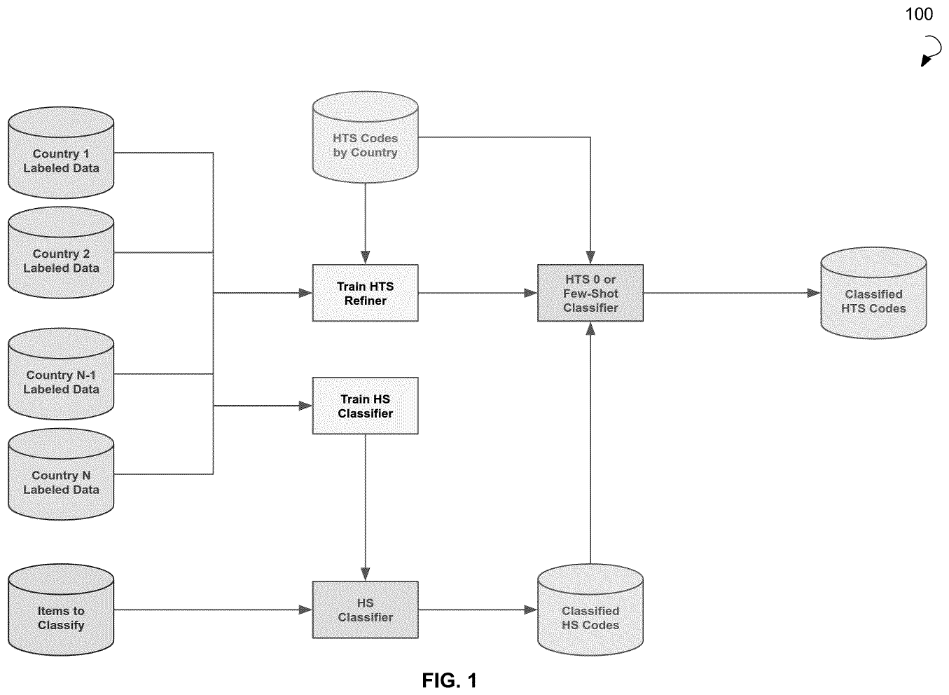

FIG. 1 illustrates a high-level block diagram 100 of an exemplary database system configured for providing globally optimal and locally specific classification of a plurality of goods using Harmonized System (HS) codes and Harmonized Tariff Schedule (HTS) codes, according to various embodiments of the present technology. Further

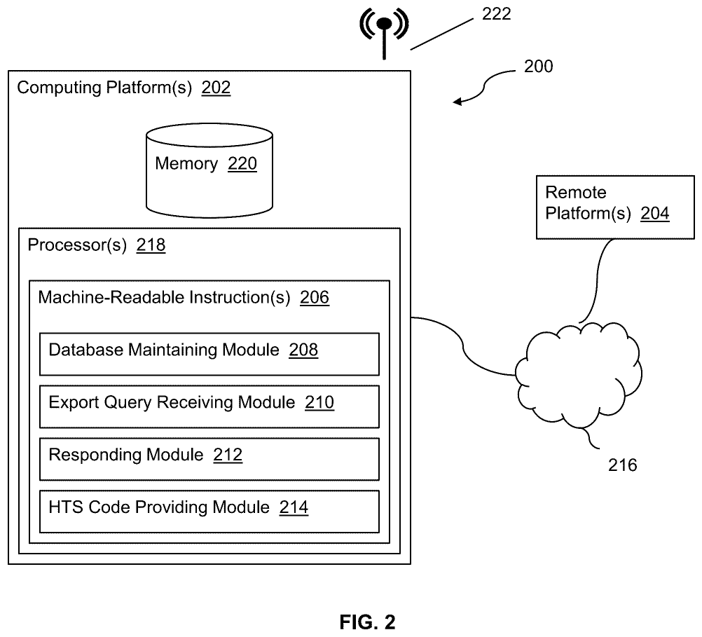

FIG. 2 illustrates a system configured for providing globally optimal and locally specific classification of a plurality of goods using Harmonized System (HS) codes and Harmonized Tariff Schedule (HTS) codes, according to various embodiments of the present technology. The present technology optimizes HS codes for global accuracy and the country-specific HTS codes by leveraging a two-phase approach, with phase one being HS classification via a global classification model, and the second phase being a general-purpose zero- or few-shot model for HTS refinement. These two phases are discussed in more detail in the below.

Phase One: HS Classification. All of the more than one-hundred-and-eighty participating markets use one of the World Customs Organization's HS codes as discussed above, which are released every five years. This harmonization allows for easy sharing of information across markets for the six-digit classification. With the knowledge of how an item should be classified to the six-digits in one country, a merchant can easily know how that same good would be classified in any other participating country. This six-digit harmonization enables a globally applicable training set of data to be curated at low cost, enabling a global classification model to be trained without sacrificing country-specific nuances through the use of a country embedding. The same approximately five-thousand possible outcome classes (HS codes) exist across markets, and therefore the present technology in various embodiments uses a bespoke model with a static set of classes. The bespoke model for the global classification model using a static set of classes allows the global classification model to share training data across all markets, learn trends globally, and still provide for market-specific nuances. Not only does this global classification model dramatically reduce the cost of acquiring labeled data, but it also allows the global classification model to be more efficient with the data that has been acquired.

Phase Two: Zero- or Few-Shot HTS Refinement.

In various embodiments of the present technology, once classification to the internationally standardized six-digit HS code is made, further refinement is needed to get to the country-specific HTS classification. To ensure this can be done in a scalable manner, a very different approach to what was valuable for Phase One is required. Instead of treating this as a typical classification problem with a static set of output classes, the refinement model needs to be flexible to calculate the probability of an item belonging to a dynamic set of classes. Therefore the present technology in some embodiments implements a zero-shot or few-shot classification. For example, a distinction between the two phases is “static” vs. “dynamic”. Furthermore, a motivating reason for the difference in the approaches is the number of classes. The classes in phase one tend to be a relatively small (e.g., 10,000s and below) predetermined set of classes. While those in phase two tend to be more numerous (i.e., several orders of magnitude higher, e.g., 1,000,000s and above) and dynamic.

In various embodiments, as permitted by the scale of a given market, a specific market could migrate from the more general zero- or few-shot paradigm to a bespoke classification model which may be more optimal. Whether or not it makes sense to make the migration for a given country can be determined empirically, and swapped as appropriate. This allows for the proper balance between scale and quality.

FIG. 2 illustrates a system configured for providing globally optimal and locally specific classification of a plurality of goods using Harmonized System (HS) codes and Harmonized Tariff Schedule (HTS) codes, in accordance with one or more embodiments. In some cases, system 200 may include one or more computing platforms 202. The one or more remote computing platforms 202 may be communicably coupled with one or more remote platforms 204. In some cases, users may access the system 200 via remote platform(s) 204.

The one or more computing platforms 202 may be configured by machine-readable instructions 206. Machine-readable instructions 206 may include modules. The modules may be implemented as one or more of functional logic, hardware logic, electronic circuitry, software modules, and the like. The modules may include one or more of database maintaining module 208, export query receiving module 210, responding module 212, Harmonized Tariff Schedule (HTS) code providing module 214, and/or other modules.

Database maintaining module 208 may be configured to maintain a database of import/export classifications for a plurality of goods comprising Harmonized System (HS) codes of the plurality of goods and Harmonized Tariff Schedule (HTS) codes of the plurality of goods. Export query receiving module 210 may be configured to receive an import/export classification request from a user for an import/export classification of a good of a cross-border commerce transaction. Responding module 212 may be configured to respond to the import/export classification request by generating a computerized classification result by searching the database of import/export classifications for the plurality of goods using a two phase approach. Harmonized Tariff Schedule (HTS) code providing module 214 may be configured to provide a Harmonized Tariff Schedule code for the good of the cross-border commerce transaction to the user in response to the import/export classification request, the providing having increased Coherence and speed compared to using a full zero-shot classification with a one phase approach.

In some cases, the two phase approach comprises: generating, during a first phase, a Harmonized System code for the good of the cross-border commerce transaction using a global classification model, the global classification model using a bespoke model with a static set of classes, and refining, during a second phase, the Harmonized System code for the good of the cross-border commerce transaction to generate a Harmonized Tariff Schedule code for the good of the cross-border commerce transaction using a locally specific model, the locally specific model using a zero-shot classification with a dynamic set of classes, the Harmonized System code may be a unique six-digit code of the good of the cross-border commerce transaction and the Harmonized Tariff Schedule code may be an eight-digit code of the good of the cross-border commerce transaction.

In some cases, the Harmonized Tariff Schedule code may be a ten-digit code of the good of the cross-border commerce transaction, the Harmonized Tariff Schedule code may be a twelve-digit code of the good of the cross-border commerce transaction and the maintaining the database comprises importing labeled classification data from a plurality of counties and training a Harmonized System classifier using the labeled classification data from the plurality of counties, the Harmonized System classifier being used for the generating, during the first phase, the Harmonized System code for the good of the cross-border commerce transaction.

In some cases, the maintaining the database further comprises storing classified HS Codes using the Harmonized System classifier, the maintaining the database comprises importing labeled classification data from a plurality of counties and training a Harmonized Tariff Schedule refiner, the Harmonized Tariff Schedule refiner being used during the second phase and the maintaining the database further comprises storing classified HTS codes using the Harmonized Tariff Schedule refiner.

In some cases, the user may be a merchant, an individual, an importer, or an exporter.

In some cases, the one or more computing platforms 202, may be communicatively coupled to the remote platform(s) 204. In some cases, the communicative coupling may include communicative coupling through a networked environment 216. The networked environment 216 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 202 and remote platform(s) 204 may be operatively linked via some other communication coupling. The one or more one or more computing platforms 202 may be configured to communicate with the networked environment 216 via wireless or wired connections. In addition, in an embodiment, the one or more computing platforms 202 may be configured to communicate directly with each other via wireless or wired connections. Examples of one or more computing platforms 202 may include, but is not limited to, smartphones, wearable devices, tablets, laptop computers, desktop computers, Internet of Things (IoT) device, or other mobile or stationary devices. In an embodiment, system 200 may also include one or more hosts or servers, such as the one or more remote platforms 204 connected to the networked environment 216 through wireless or wired connections. According to one embodiment, remote platforms 204 may be implemented in or function as base stations (which may also be referred to as Node Bs or evolved Node Bs (eNBs)). In other embodiments, remote platforms 204 may include web servers, mail servers, application servers, etc. According to certain embodiments, remote platforms 204 may be standalone servers, networked servers, or an array of servers.

The one or more computing platforms 202 may include one or more processors 218 for processing information and executing instructions or operations. One or more processors 218 may be any type of general or specific purpose processor. In some cases, multiple processors 218 may be utilized according to other embodiments. In fact, the one or more processors 218 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 218 may be remote from the one or more computing platforms 202, such as disposed within a remote platform like the one or more remote platforms 204 of FIG. 2.

The one or more processors 218 may perform functions associated with the operation of system 200 which may include, for example, precoding of antenna gain/phase parameters, encoding and decoding of individual bits forming a communication message, formatting of information, and overall control of the one or more computing platforms 202, including processes related to management of communication resources.

The one or more computing platforms 202 may further include or be coupled to a memory 220 (internal or external), which may be coupled to one or more processors 218, for storing information and instructions that may be executed by one or more processors 218. Memory 220 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 220 can consist of any combination of random access memory (RAM), read only memory (ROM), static storage such as a magnetic or optical disk, hard disk drive (HDD), or any other type of non-transitory machine or computer readable media. The instructions stored in memory 220 may include program instructions or computer program code that, when executed by one or more processors 218, enable the one or more computing platforms 202 to perform tasks as described herein.

In some embodiments, one or more computing platforms 202 may also include or be coupled to one or more antennas 222 for transmitting and receiving signals and/or data to and from one or more computing platforms 202. The one or more antennas 222 may be configured to communicate via, for example, a plurality of radio interfaces that may be coupled to the one or more antennas 222. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

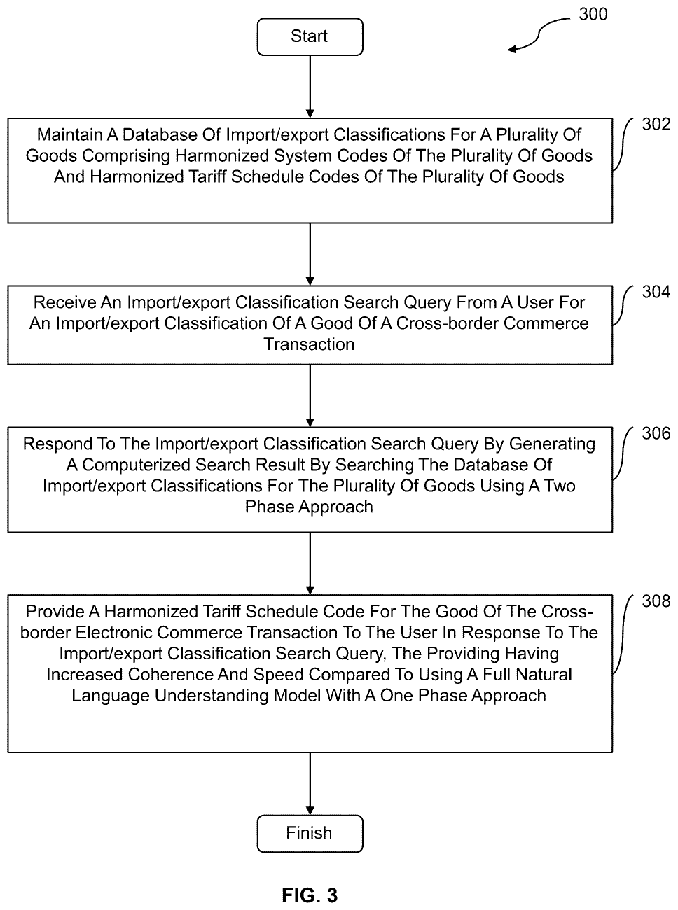

FIG. 3 illustrates an example flow diagram of a method 300, according to one embodiment. The method 300 may include maintaining a database of import/export classifications for a plurality of goods comprising Harmonized System codes of the plurality of goods and Harmonized Tariff Schedule codes of the plurality of goods at block 302. The method 300 may include receiving an import/export classification request from a user for an import/export classification of a good of a cross-border commerce transaction at block 304. The method 300 may include responding to the import/export classification request by generating a computerized classification result by searching the database of import/export classifications for the plurality of goods using a two phase approach at block 306. The method 300 may include providing a Harmonized Tariff Schedule code for the good of the cross-border commerce transaction to the user in response to the import/export classification request, the providing having increased Coherence and speed compared to using a full zero-shot classification with a one phase approach at block 308.

In some cases, the method 300 may be performed by one or more hardware processors, such as the processors 218 of FIG. 2, configured by machine-readable instructions, such as the machine-readable instructions 206 of FIG. 2. In this aspect, the method 300 may be configured to be implemented by the modules, such as the database maintaining module 208, export query receiving module 210, responding module 212 and/or Harmonized Tariff Schedule (HTS) code providing module 214 discussed above in FIG. 2.

In various embodiments the technical effect of the present technology is providing a Harmonized Tariff Schedule (HTS) code for the good of the cross-border commerce transaction to the user in response to the import/export classification request, the providing having increased Coherence and speed compared to using a full zero-shot classification with a one phase approach. Coherence means a similarity of a predicted classification using the present technology to a classification made by an expert human. Coherence may be a measure of quality for a classification. For example, the data below in Table I show how similar the predicted code is to the human labeled code, in other words increase accuracy of Zero Shot Classification using the present technology of a sample of seventy-two goods/items. Additionally, Table I shows speed improvements.

Table I includes the following rows: seventy-two goods/items. Table I includes the following columns Good or Item, Full Zero Shot Duration, Zero Shot Coherence, Duration, Coherence, and Speed Improvement. Specifically, Table I shows increased Coherence and speed improvement of the present technology compared to using a full zero-shot classification with a one phase approach.

| | Full Zero | | Zero Shot | | | | Speed |
|---|---|---|---|---|---|---|---|
| Good or Item | Shot Duration | | Coherence | Duration | | Coherence | Improvement |
| Bags. Coach Leather Wristlet. | 2788.7 | ms | 0% | 17.5 | ms | 80% | 159.8x |
| Gifts, Coach, Coach leather | | | | | | | |
| universal phone case\\n Zip | | | | | | | |
| around with wristlet strap\\n | | | | | | | |
| Black with silver hardware\\n 1 | | | | | | | |
| exterior pocket\\n 3 interior card | | | | | | | |
| slots\\n New with tag and dust | | | | | | | |
| cover | | | | | | | |
| Nine West Hong Kong YB | 3046.7 | ms | 3% | 10.3 | ms | 100% | 296.5x |
| Brochure. Catalogs Printed | | | | | | | |
| Bravo Shadowbox Certificate. | 1668.6 | ms | 0% | 12.7 | ms | 100% | 131.1x |
| Printed Cards Certs other | | | | | | | |
| UPCO US Yearbook Brochure. | 3131.6 | ms | 5% | 10.9 | ms | 100% | 287.3x |
| Catalogs Printed | | | | | | | |
| memory foam mattress topper. | 5843.5 | ms | 0% | 22.6 | ms | 100% | 258.5x |
| Authentic Comfort Bio fresh 3. | | | | | | | |
| The Authentic Comfort 3″ | | | | | | | |
| Memory Foam Mattress Topper | | | | | | | |
| Made with Biofresh is the first | | | | | | | |
| of its kind to be odor neutralized | | | | | | | |
| and effortlessly breathable. | | | | | | | |
| Three inches of ventilated, open- | | | | | | | |
| cell memory foam prevent heat | | | | | | | |
| and moisture accumulation | | | | | | | |
| through its superior airflow | | | | | | | |
| qualities, keeping the topper | | | | | | | |
| cool, fresh and hygienic. The | | | | | | | |
| open-cell structure of Biofresh | | | | | | | |
| provides a longer life span than | | | | | | | |
| traditional memory foam by | | | | | | | |
| delivering unmatched durability | | | | | | | |
| that resists body impressions and | | | | | | | |
| maintains its original shape. This | | | | | | | |
| memory foam mattress topper | | | | | | | |
| brings an unparalleled sense of | | | | | | | |
| luxury and comfort to each night | | | | | | | |
| of sleep as it cradles your body's | | | | | | | |
| every curve. | | | | | | | |
| minecraft diamond sword. | 3149.0 | ms | 3% | 10.7 | ms | 33% | 295.5x |
| Lillian Rose CN100 A Diamond | | | | | | | |
| Confetti - Aqua | | | | | | | |
| Dog Tag Air Force Seal | 1410.7 | ms | 0% | 11.1 | ms | 100% | 126.8x |
| Harbor Chambray Shirt \| | 3253.9 | ms | 0% | 10.1 | ms | 100% | 322.1x |
| Nantucket Red XL | | | | | | | |
| food. Korean sauce/oil/sauce. | 1856.4 | ms | 0% | 11.6 | ms | 100% | 159.9x |
| Giovanni Organic Spicy Tomato | | | | | | | |
| Pasta Sauce | | | | | | | |
| bluetooth speaker. Bluetooth | 6183.2 | ms | 0% | 25.9 | ms | 100% | 239.1x |
| Wireless Shower Hands-free | | | | | | | |
| Speaker Phone/Speaker. This | | | | | | | |
| Bluetooth speaker plays your | | | | | | | |
| music wirelessly and allows call | | | | | | | |
| answering in the shower. This | | | | | | | |
| speaker is compatible with any | | | | | | | |
| Bluetooth media, MP3 player or | | | | | | | |
| smartphone. The waterproof | | | | | | | |
| sealing protects this device from | | | | | | | |
| water splashes from any angle. | | | | | | | |
| This speaker is completely | | | | | | | |
| hands-free for ease of use. \\n \\n | | | | | | | |
| Full-range speaker\\n | | | | | | | |
| Rechargeable through USB | | | | | | | |
| cable charger\\n Power source: | | | | | | | |
| DC 3.7-volt, 400 mA\\n | | | | | | | |
| Impedance of speakers: 3-watt, | | | | | | | |
| 4-ohm\\n Battery parameter: 3.7- | | | | | | | |
| volt 50 mA\\n SNR: >60 dB\\n | | | | | | | |
| Set includes: Speaker, user | | | | | | | |
| manual, audio cable, USB | | | | | | | |
| cable\\n Color options: Black, | | | | | | | |
| blue, green\\n Model: | | | | | | | |
| PWPBT10\\n Shipping | | | | | | | |
| dimensions: 5 inches high × 5 | | | | | | | |
| inches wide × 5 inches deep\\n | | | | | | | |
| Weight: 1 pound | | | | | | | |
| Watch women fossil. Fossil | 3650.5 | ms | 0% | 14.2 | ms | 100% | 257.5x |
| Women's ‘Stella’ Multifunction | | | | | | | |
| Rose-goldtone Dial Watch. | | | | | | | |
| Rose-goldtone stainless steel | | | | | | | |
| makes for a uniquely refined | | | | | | | |
| look in this stunning women's | | | | | | | |
| watch from Fossil. Day, date and | | | | | | | |
| 24-hour subdials, luminescent | | | | | | | |
| hands and a stainless steel link | | | | | | | |
| bracelet finish this sharp | | | | | | | |
| timepiece. | | | | | | | |
| Bird seed feeder. Droll Yankees | 7429.1 | ms | 60% | 30.4 | ms | 14% | 244.2x |
| Ring Pull 23 Sunflower/Mixed | | | | | | | |
| Seed Feeder”. Now it's easier | | | | | | | |
| than ever to give songbirds just | | | | | | | |
| what they need fresh food from a | | | | | | | |
| clean, hygienic feeder. Droll | | | | | | | |
| Yankees Ring Pull Feeders offer | | | | | | | |
| a fresh, modern, no tools needed | | | | | | | |
| approach to cleaning with the | | | | | | | |
| Ring Pull Advantage. This is a | | | | | | | |
| 15″ Midnight Blue | | | | | | | |
| Sunflower/Mixed Seed Feeder. | | | | | | | |
| No tools needed to disassemble | | | | | | | |
| for cleaning simply lift the cap, | | | | | | | |
| then pull the metal rod to | | | | | | | |
| remove the ports and feeder base | | | | | | | |
| in just seconds. It is made with | | | | | | | |
| rust proof metal parts and has a | | | | | | | |
| UV-stabilized polycarbonate | | | | | | | |
| tube. Lifetime Warranty against | | | | | | | |
| squirrel damage. | | | | | | | |
| Emblem SS GLOBE Zipper Pull | 1847.4 | ms | 0% | 9.9 | ms | 100% | 185.9x |
| Johnson Matt. Jewelry/Parts Of | | | | | | | |
| Silver | | | | | | | |
| AY McDonald YB Design. | 2963.4 | ms | 3% | 10.6 | ms | 100% | 279.5x |
| Catalogs Printed | | | | | | | |
| Ames Farm 2 oz Single Source | 3208.2 | ms | 0% | 10.2 | ms | 18% | 314.3x |
| Honey. Honey | | | | | | | |
| MSM - Secret Squirrel | 1055.4 | ms | 0% | 10.3 | ms | 100% | 103.0x |
| (PVC/Swat) | | | | | | | |
| food. Powder/Seasoning/ | 1797.1 | ms | 0% | 10.5 | ms | 41% | 170.8x |
| Spices. Bread Garden Plain | | | | | | | |
| Bread Mix | | | | | | | |
| hair accessories. BMC Women's | 7490.2 | ms | 0% | 29.7 | ms | 80% | 252.5x |
| 5 pc Foam Rabbit Ear Hair Tie | | | | | | | |
| Accessories - Set 2: Stars + | | | | | | | |
| Flowers. These soft foam rabbit | | | | | | | |
| ear hair ties are an easy and | | | | | | | |
| fashionable way to style your | | | | | | | |
| hair. This is Set 2, featuring star | | | | | | | |
| and flower pattern hair ties in 5 | | | | | | | |
| different colors. These hair ties | | | | | | | |
| are made of multicolor foam | | | | | | | |
| wrapped around a piece of soft | | | | | | | |
| pliable metal. It's a simple way | | | | | | | |
| to achieve a super cute look. | | | | | | | |
| Instructions: (as shown on | | | | | | | |
| packaging) 1- Put hair through | | | | | | | |
| the slit on the hair tie. 2 - Roll | | | | | | | |
| the hair tie inward to create one | | | | | | | |
| tight roll of hair. 3 - Pull the hair | | | | | | | |
| tie up in a loop to get the hair | | | | | | | |
| roll in a bun shape. 4 - Twist the | | | | | | | |
| rabbit ears around each other to | | | | | | | |
| lock this look into place. | | | | | | | |
| *NOTE*: Due to differences | | | | | | | |
| between monitor displays, actual | | | | | | | |
| color may vary slightly from | | | | | | | |
| image. b.m.c is a registered | | | | | | | |
| trademark of Remi Collections | | | | | | | |
| LLC and is exclusively | | | | | | | |
| distributed by Bundle Monster. | | | | | | | |
| The b.m.c trademark is protected | | | | | | | |
| by US Trademark Law.\\n This 5 | | | | | | | |
| piece set features star and flower | | | | | | | |
| pattern hair ties in 5 different | | | | | | | |
| colors.\\n Made up of patterned | | | | | | | |
| foam wrapped around pliable | | | | | | | |
| metal.\\n Hair ties are about 14.3 | | | | | | | |
| in. long. The slit to put your hair | | | | | | | |
| through is 4.4 in. long.\\n The | | | | | | | |
| package comes with easy to | | | | | | | |
| follow images and instructions. | | | | | | | |
| See description for more | | | | | | | |
| details.\\n Great for girls and | | | | | | | |
| women of all ages, and any | | | | | | | |
| occasion. | | | | | | | |
| Celestron 51635 Starpointer Pro | 1915.9 | ms | 0% | 10.9 | ms | 100% | 175.7x |
| Finderscope. BINOCULARS, | | | | | | | |
| OTHER OPTICAL | | | | | | | |
| TELESCOPES PARTS | | | | | | | |
| food. snack. Orion Chickenpop | 3606.6 | ms | 0% | 13.1 | ms | 100% | 274.8x |
| Korean Fried Chicken Flavored | | | | | | | |
| Chicken Rice Krispies | | | | | | | |
| tablet accessories. TG Universal | 4467.1 | ms | 10% | 19.2 | ms | 0% | 232.9x |
| Tablet Stand. Expand the | | | | | | | |
| functionality of your tablet with | | | | | | | |
| the easy-to-use TG Universal | | | | | | | |
| Tablet Stand. It allows the user | | | | | | | |
| to angle the device for optimal | | | | | | | |
| viewing. It includes non-slip | | | | | | | |
| rubber feet to prevent it from | | | | | | | |
| moving about on your tabletop, | | | | | | | |
| counter or other surface. This | | | | | | | |
| universal tablet holder can be | | | | | | | |
| utilized horizontally or vertically | | | | | | | |
| to watch movies and videos | | | | | | | |
| hands-free or to conveniently | | | | | | | |
| view recipes while in the | | | | | | | |
| kitchen.\\n TG Universal Tablet | | | | | | | |
| Stand\\n Holds tablets in both | | | | | | | |
| landscape and portrait | | | | | | | |
| orientations\\n Rubber non-slip | | | | | | | |
| feet\\n Breaks down for space | | | | | | | |
| saving storage\\n Dimensions: | | | | | | | |
| 6.5″ × 4.875″ × 6″\\n This iPad | | | | | | | |
| tablet stand is suitable for hands- | | | | | | | |
| free viewing of movies and | | | | | | | |
| videos\\n Designed to | | | | | | | |
| accommodate a wide variety of | | | | | | | |
| tablet devices | | | | | | | |
| Trade Show. Tech Accessories. | 1920.9 | ms | 8% | 13.8 | ms | 100% | 139.2x |
| cable organizer. These Cable | | | | | | | |
| Organizers can bundle cables, | | | | | | | |
| cords wires or keys. With a pull | | | | | | | |
| through imprint area, these | | | | | | | |
| organizers can even be used as a | | | | | | | |
| wine glass markers at | | | | | | | |
| events/parties or as luggage | | | | | | | |
| spotter tags. | | | | | | | |
| Wire Storage. Safco 48″ × 24″ | 3306.4 | ms | 7% | 11.6 | ms | 100% | 285.2x |
| Industrial Wire Shelving in | | | | | | | |
| Black | | | | | | | |
| bike lock. Thule Replacement | 3159.2 | ms | 1% | 11.1 | ms | 0% | 283.6x |
| Lock Latch - Sportrack - 05604 | | | | | | | |
| Everyday Lace T-Shirt Bra, | 3379.5 | ms | 0% | 10.4 | ms | 100% | 324.8x |
| Twilight, 40H | | | | | | | |
| Petzl - COEUR Bolt Steel - | 1164.4 | ms | 0% | 11.4 | ms | 0% | 102.2x |
| 10 mm - 20 pk | | | | | | | |
| Black/Beige Abstract Fabric | 3224.3 | ms | 0% | 10.2 | ms | 80% | 315.5x |
| Club Chair | | | | | | | |
| food. snack. Malt and Mill | 3274.6 | ms | 0% | 13.8 | ms | 19% | 237.4x |
| Honey Nut Scooter | | | | | | | |
| Cleanser/Depilatory/Slimming. | 2539.8 | ms | 3% | 13.0 | ms | 100% | 194.7x |
| Depilatory/wax strip. Viera | | | | | | | |
| Azulene Soft Wax Turquoise | | | | | | | |
| Hannah Round 42″ Double Drop | 1390.2 | ms | 0% | 10.1 | ms | 100% | 137.0x |
| Leaf Gate Leg Dining Table | | | | | | | |
| ST M #19 Satin Dbl SS Inlay | 2043.7 | ms | 0% | 11.6 | ms | 100% | 176.7x |
| (1)5 pt 8.0. Jewelry/Parts | | | | | | | |
| Precious Metal | | | | | | | |
| food. fresh food. Nonghyup | 3471.0 | ms | 0% | 10.3 | ms | 100% | 336.0x |
| Boeun Haetttteul Kidney Beans | | | | | | | |
| Cooking oil/oil/sesame oil. | 2014.3 | ms | 0% | 14.3 | ms | 80% | 141.2x |
| Sesame oil. Olga Whole Foods | | | | | | | |
| Germinated Sesame Oil | | | | | | | |
| food. fresh food. Gwangcheon | 3778.8 | ms | 0% | 11.5 | ms | 22% | 327.9x |
| seaweed master Kim Byung- | | | | | | | |
| man&#39;s seaweed triangle | | | | | | | |
| seaweed | | | | | | | |
| ROSEN SUN VISOR FOR | 1183.9 | ms | 0% | 10.5 | ms | 15% | 112.9x |
| CESSNA 150-207 (side mount) | | | | | | | |
| pots and pans set. T-FAL | 2511.7 | ms | 4% | 11.9 | ms | 30% | 211.7x |
| Initiatives 18-Piece Red | | | | | | | |
| Cookware Set Non-stick Inside | | | | | | | |
| & Out Pots and Pans | | | | | | | |
| zippo hand warmer. Zippo Hand | 2998.2 | ms | 0% | 14.6 | ms | 100% | 205.8x |
| Warmer High Polish Chrome | | | | | | | |
| 40306. Enjoy the great outdoors | | | | | | | |
| even when it's cold outside. It's | | | | | | | |
| sleek, thin design easily fits into | | | | | | | |
| pockets, is virtually odorless | | | | | | | |
| (great for hunters) and stays | | | | | | | |
| warm up to 12 hours. Includes | | | | | | | |
| convenient filler cup and | | | | | | | |
| warming bag. Does not include | | | | | | | |
| fuel. Color: High Polish | | | | | | | |
| Chrome. | | | | | | | |
| L-TYROSINE 750 mg. L- | 2966.9 | ms | 0% | 12.9 | ms | 100% | 230.0x |
| tyrosine is a non-essential amino | | | | | | | |
| acid that plays an important role | | | | | | | |
| in the production of | | | | | | | |
| neurotransmitters dopamine and | | | | | | | |
| norepinephrine. | | | | | | | |
| food. coffee Tea. Dongwoodang | 3144.6 | ms | 0% | 11.7 | ms | 100% | 269.9x |
| wormwood tea | | | | | | | |
| food. Powder/Seasoning/ | 2382.3 | ms | 0% | 11.4 | ms | 0% | 209.3x |
| Spices. The Fresh Jang Nara | | | | | | | |
| Natural Rice 30% Low Salt | | | | | | | |
| Newborn miscellaneous goods. | 2188.8 | ms | 17% | 13.0 | ms | 34% | 167.9x |
| Outer/inner wrap. Agabang Bear | | | | | | | |
| Supima Soksabo | | | | | | | |
| 01P084415AGA, GREY | | | | | | | |
| rachel ray cookware. Rachael | 11674.0 | ms | 0% | 39.9 | ms | 30% | 292.5x |
| Ray 18 × 10-in. Hard Anodized II | | | | | | | |
| Double Burner Grill with Pour | | | | | | | |
| Spout. Rachael Ray 18 × 10-in. | | | | | | | |
| Hard Anodized II Double Burner | | | | | | | |
| Grill with Pour Spout\\n \\n Rain | | | | | | | |
| or shine, bring grilling indoors to | | | | | | | |
| the stovetop with the Rachael | | | | | | | |
| Ray Hard Anodized II Nonstick | | | | | | | |
| 18-in by 10-in Double Burner | | | | | | | |
| Grill with Pour Spout. This | | | | | | | |
| double burner grill is perfect for | | | | | | | |
| making Rachael yummy Cheese | | | | | | | |
| Fry Chili Burgers or her | | | | | | | |
| Rosemary-Garlic Steaks with | | | | | | | |
| Arugula, Tomatoes and | | | | | | | |
| Parmigiano Reggiano, because | | | | | | | |
| the durable hard-anodized | | | | | | | |
| construction promotes even | | | | | | | |
| heating to reduce hot spots that | | | | | | | |
| can often burn foods. The | | | | | | | |
| interior features a long-lasting | | | | | | | |
| nonstick coating which releases | | | | | | | |
| foods effortlessly and cleanup is | | | | | | | |
| a snap. The ridges provide the | | | | | | | |
| much-desired grill marks for | | | | | | | |
| burgers, chicken and veggies just | | | | | | | |
| like an outside barbecue grill. | | | | | | | |
| The professional quality | | | | | | | |
| stainless steel handles are | | | | | | | |
| double-riveted for extra strength, | | | | | | | |
| and the handy pour spot makes it | | | | | | | |
| easy to pour off pan drippings. | | | | | | | |
| The cookware is also oven safe | | | | | | | |
| to 500 F. for convenience. With | | | | | | | |
| this double burner grill and other | | | | | | | |
| Rachael Ray cookware and | | | | | | | |
| bakeware pieces, cooking at | | | | | | | |
| home has never been so fun. Fire | | | | | | | |
| up some indoor barbecuing with | | | | | | | |
| the Rachael Ray Hard Anodized | | | | | | | |
| II Nonstick 18-Inch by 10-Inch | | | | | | | |
| Double Burner Grill with Pour | | | | | | | |
| Spout that brings grilling to the | | | | | | | |
| stovetop. Features: Hard- | | | | | | | |
| anodized construction promotes | | | | | | | |
| even heating. Oven safe to 500 F. | | | | | | | |
| Seaguar Blue Label 25 Yards | 3574.0 | ms | 4% | 14.0 | ms | 80% | 254.9x |
| Fluorocarbon Leader 30-Pounds. | | | | | | | |
| FISHING REELS PARTS AND | | | | | | | |
| ACCESSORIES | | | | | | | |
| Jewellery & Watches. Jewellery. | 5211.0 | ms | 0% | 17.2 | ms | 100% | 303.7x |
| 14 kt. White gold - Ring 0.22 ct | | | | | | | |
| Diamond. Center | | | | | | | |
| Stone: \n\nNatural | | | | | | | |
| Diamond\nCut: Round | | | | | | | |
| Brilliant\nCarat: 0.22 Carat | | | | | | | |
| \nSize: 3.9 mm \nColor: Colour- | | | | | | | |
| treated Fancy Blue | | | | | | | |
| Diamond.\nClarity: | | | | | | | |
| SI2\n\nCondition: \nShipping: | | | | | | | |
| Will be sent fedex with | | | | | | | |
| insurance\nCustoms and import | | | | | | | |
| fees are sole responsibility of | | | | | | | |
| buyer | | | | | | | |
| 24/7 Lace Balconette Bra, | 1234.4 | ms | 0% | 11.7 | ms | 100% | 105.5x |
| Sunflower, 34A1/2 | | | | | | | |
| Satin Demi, Sea Salt, 34A | 1020.4 | ms | 0% | 10.8 | ms | 100% | 94.8x |
| Trash Bags. Trash | 3542.0 | ms | 1% | 13.0 | ms | 56% | 273.2x |
| Bag,Black,40 in W × 46 in L, PK250 | | | | | | | |
| Rechargable batteries. eneloop | 2360.5 | ms | 0% | 11.1 | ms | 36% | 211.7x |
| Rechargeable Batteries, 4-pack | | | | | | | |
| AA Office Supplies | | | | | | | |
| Jump Ring Set of 5 6 MM SS. | 3324.2 | ms | 0% | 10.7 | ms | 80% | 309.6x |
| Jewelry Base Metal w/Precious | | | | | | | |
| Metal | | | | | | | |
| food. fresh food. blue sea shrimp | 3601.8 | ms | 0% | 14.5 | ms | 30% | 247.8x |
| food. Healthy Food. DANAUM | 3853.7 | ms | 0% | 12.4 | ms | 0% | 311.7x |
| Vitamin D 1000IU Softgel for | | | | | | | |
| Children | | | | | | | |
| Gen Ameth Rnd #1 2.4-2.64 mm | 2327.9 | ms | 0% | 13.1 | ms | 100% | 178.3x |
| 9 ss. Gems Other Cut But Not Set | | | | | | | |
| dollhouse bathtub. Just Dreamz | 3863.8 | ms | 0% | 15.6 | ms | 100% | 247.3x |
| Bathroom Dollhouse Furniture | | | | | | | |
| Set. Your child will enjoy hours | | | | | | | |
| of play with this Just Dreamz | | | | | | | |
| furniture set. This beautiful | | | | | | | |
| wooden furniture set is designed | | | | | | | |
| to fit perfectly inside a | | | | | | | |
| dollhouse. The 5 piece bathroom | | | | | | | |
| set includes a bathtub, sink, | | | | | | | |
| toilet, wastebasket, and rug. | | | | | | | |
| Collect all furniture sets from the | | | | | | | |
| Just Dreamz collection to | | | | | | | |
| decorate the entire house. | | | | | | | |
| eye cream. Philosophy Eye Hope | 7782.3 | ms | 0% | 19.7 | ms | 80% | 395.6x |
| Advanced Anti-Aging Eye | | | | | | | |
| Cream 0.5 oz. What it is: An | | | | | | | |
| antiaging eye treatment that | | | | | | | |
| reduces puffiness. What it is | | | | | | | |
| formulated to do: Philosophy Eye | | | | | | | |
| Hope(TM) Advanced Anti- | | | | | | | |
| Aging Eye Cream provides | | | | | | | |
| moisture and protection for the | | | | | | | |
| delicate eye area. It is designed | | | | | | | |
| to diminish dark circles, reduce | | | | | | | |
| puffiness, and minimize the | | | | | | | |
| appearance of fine lines and | | | | | | | |
| wrinkles. A dose of antioxidants | | | | | | | |
| fortifies skin against future | | | | | | | |
| damage. What else you need to | | | | | | | |
| know: This formula contains beta | | | | | | | |
| glucan, an agent that has been | | | | | | | |
| shown to help address aging | | | | | | | |
| concerns such as wrinkles and | | | | | | | |
| loss of skin elasticity and tone. | | | | | | | |
| In this product, beta glucan | | | | | | | |
| works synergistically with a | | | | | | | |
| team of age-fighting | | | | | | | |
| counterparts to deliver serious | | | | | | | |
| results. | | | | | | | |
| URO Parts MJA3980AD Power | 1140.1 | ms | 1% | 11.2 | ms | 0% | 101.7x |
| Streering Suction Hose | | | | | | | |
| Silicone Sculpture. The | 2937.9 | ms | 0% | 12.0 | ms | 0% | 244.8x |
| commodity description and HS | | | | | | | |
| code approved by UPS and | | | | | | | |
| FedEx for sex toys. This will not | | | | | | | |
| be changed. | | | | | | | |
| Rechargeable batteries. Go | | | | | | 36% | 363.6x |
| Green AAA Alkaline Battery 8- | | | | | | | |
| pack. Go Green AAA Alkaline | | | | | | | |
| Batteries are independently | | | | | | | |
| tested to verify performance like | | | | | | | |
| the more expensive brands. | 5383.3 | ms | 0% | 14.8 | ms | | |
| Environmentally friendly, | | | | | | | |
| contains no lead, Cadmium, or | | | | | | | |
| Mercury. Made from 100- | | | | | | | |
| percent recycled materials. | | | | | | | |
| Clock Cabinet HM Marcella | 3842.0 | ms | 10% | 13.4 | ms | 80% | 287.6x |
| 611-296. Clocks - Electrically | | | | | | | |
| Operated | | | | | | | |
| Counterweight - Replacement | 3974.2 | ms | 0% | 11.3 | ms | 2% | 352.1x |
| for MIO Rigs - 42 lbs | | | | | | | |
| Other snacks wonmul. Other | 1931.8 | ms | 6% | 12.6 | ms | 100% | 153.2x |
| snacks wonmul. Terra Chips | | | | | | | |
| Real Vegetable Chips | | | | | | | |
| Mediterranean Herb & A Hint of | | | | | | | |
| Lemon | | | | | | | |
| Box G750 ZP. Non-Corrugated | 3398.0 | ms | 0% | 10.5 | ms | 100% | 324.8x |
| Box Folding | | | | | | | |
| handicrafts. fabric. | 3923.6 | ms | 0% | 12.9 | ms | 12% | 303.8x |
| Cheonmadang Shibori 2 to 1 | | | | | | | |
| Golgi Apple Green 1 hemp, 30 × | | | | | | | |
| 90 cm, 1 pc | | | | | | | |
| Fashion. sportswear. Hyman | 3805.4 | ms | 0% | 11.5 | ms | 100% | 331.6x |
| Bike HMBF Pad Part 9 Raised | | | | | | | |
| Bib Tights | | | | | | | |
| HGI M UA Perf Polo-Ryl Blue - | 1244.4 | ms | 0% | 11.4 | ms | 100% | 109.3x |
| SM | | | | | | | |
| Shoes. Soludos Canvas Platform | 2985.7 | ms | 0% | 13.0 | ms | 100% | 230.0x |
| Smoking Slipper Espadrilles. | | | | | | | |
| Women, Soludos, Soludos | | | | | | | |
| Canvas Platform Smoking | | | | | | | |
| Slipper Espadrilles \\n Womens | | | | | | | |
| size 9\\n Great used condition \\n | | | | | | | |
| No box | | | | | | | |
| Jewellery & Watches. Jewellery. | 6607.5 | ms | 0% | 16.0 | ms | 100% | 412.9x |
| 15 kt. Yellow gold - Brooch. | | | | | | | |
| Antique yellow gold | | | | | | | |
| brooch.\ndark brown/black seed | | | | | | | |
| fruit\nlined with yellow gold | | | | | | | |
| decoration above/below\npin | | | | | | | |
| length 35.28 mm\nwidth ″3.49 | | | | | | | |
| mm\nClasp: perfect\nweight | | | | | | | |
| 3.33 grams\n\npackaged in a | | | | | | | |
| jewellery box \nregistered | | | | | | | |
| shipping by PostNL | | | | | | | |
| food. fresh food. Itu0027s Real | 3471.0 | ms | 0% | 11.2 | ms | 100% | 309.9x |
| Nuts Berry Yogurt Mixed Nuts | | | | | | | |
| mother and baby. baby food. | 3528.2 | ms | 0% | 10.9 | ms | 80% | 323.1x |
| Chikimongki Woori Wheat | | | | | | | |
| Noodles 30 g | | | | | | | |
| Double Antique Brass Up Large | 1343.6 | ms | 0% | 14.6 | ms | 0% | 91.9x |
| Tray | | | | | | | |
| rain jacket. Nuage Women's | 3151.4 | ms | 0% | 13.6 | ms | 80% | 232.2x |
| Valencia Jacket | | | | | | | |
| Baby carrier/hip | 2392.4 | ms | 17% | 11.7 | ms | 100% | 204.6x |
| seat/blanket/accessory. Baby | | | | | | | |
| carrier/hip seat/carrier. Bung | | | | | | | |
| Bung Mall Premium Hip Seat | | | | | | | |
| Baby Carrier, Gray | | | | | | | |
| Fashion. Casual wear. Elamo | 3541.9 | ms | 0% | 11.4 | ms | 80% | 311.7x |
| Brushed H Beige Egg Hoodie | | | | | | | |
| AVERAGE | 3274.7 | ms | 2% | 13.6 | ms | 70% | 237.4x |

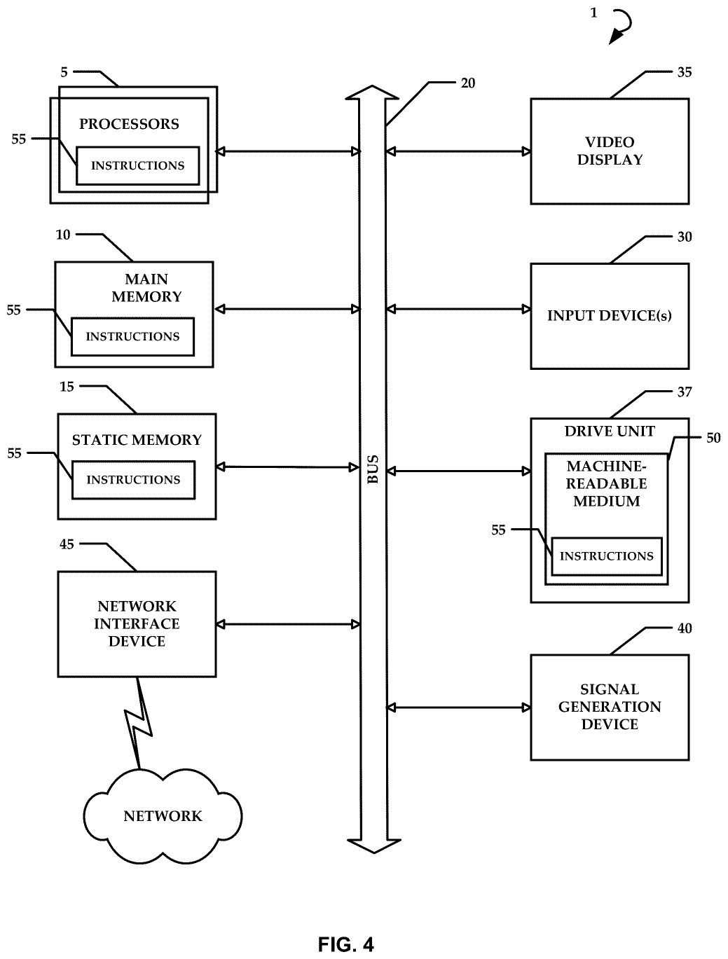

FIG. 4 illustrates an exemplary computer system that may be used to implement embodiments of the present technology. FIG. 4 illustrates a computer system for implementing systems and methods according to exemplary embodiments of the present technology. FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 are those typically found in computer systems that may be suitable for use with embodiments of the present disclosure and are intended to represent a broad category of such computer components that are well known in the art. Thus, the computer system 1 can be a personal computer (PC), handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A computer-implemented method for providing classification of a plurality of goods using Harmonized System (HS) codes and Harmonized Tariff Schedule (HTS) codes, comprising:
maintaining a database of import/export classifications for a plurality of goods comprising Harmonized System (HS) codes of the plurality of goods and Harmonized Tariff Schedule (HTS) codes of the plurality of goods;
receiving an import/export classification request from a user for an import/export classification of a good of a cross-border commerce transaction;
responding to the import/export classification request by generating a computerized classification result by searching the database of import/export classifications for the plurality of goods using a two phase approach, the two phase approach comprising:
generating, during a first phase, a Harmonized System (HS) code for the good of the cross-border commerce transaction using a global classification model, the global classification model using a bespoke model with a static set of classes; and
refining, during a second phase, the Harmonized System (HS) code for the good of the cross-border commerce transaction to generate a Harmonized Tariff Schedule (HTS) code for the good of the cross-border commerce transaction using a locally specific model, the locally specific model using a zero-shot classification with a dynamic set of classes; and
providing a Harmonized Tariff Schedule (HTS) code for the good of the cross-border commerce transaction to the user in response to the import/export classification request, the providing having increased Coherence and speed compared to using a full zero-shot classification with a one phase approach.

2. The computer-implemented method of claim 1, wherein the Harmonized System (HS) code is a unique six-digit code of the good of the cross-border commerce transaction.

3. The computer-implemented method of claim 1, wherein the Harmonized Tariff Schedule (HTS) code is an eight-digit code of the good of the cross-border commerce transaction.

4. The computer-implemented method of claim 1, wherein the Harmonized Tariff Schedule (HTS) code is a ten-digit code of the good of the cross-border commerce transaction.

5. The computer-implemented method of claim 1, wherein the Harmonized Tariff Schedule (HTS) code is a twelve-digit code of the good of the cross-border commerce transaction.

6. The computer-implemented method of claim 1, wherein the maintaining the database comprises importing labeled classification data from a plurality of counties and training a Harmonized System (HS) classifier using the labeled classification data from the plurality of counties, the Harmonized System (HS) classifier being used for the generating, during the first phase, the Harmonized System (HS) code for the good of the cross-border commerce transaction.

7. The computer-implemented method of claim 6, wherein the maintaining the database further comprises storing classified HS Codes using the Harmonized System (HS) classifier.

8. The computer-implemented method of claim 1, wherein the maintaining the database comprises importing labeled classification data from a plurality of counties and training a Harmonized Tariff Schedule (HTS) refiner, the Harmonized Tariff Schedule (HTS) refiner being used during the second phase.

9. The computer-implemented method of claim 8, wherein the maintaining the database further comprises storing classified HTS codes using the Harmonized Tariff Schedule (HTS) refiner.

10. The computer-implemented method of claim 1, wherein the user is a merchant, an individual, an importer, or an exporter.

11. An apparatus for providing classification of a plurality of goods using Harmonized System (HS) codes and Harmonized Tariff Schedule (HTS) codes, comprising:
at least one memory storing computer program instructions; and
at least one processor configured to execute the computer program instructions to cause the apparatus at least to:
maintain a database of import/export classifications for a plurality of goods comprising Harmonized System codes of the plurality of goods and Harmonized Tariff Schedule codes of the plurality of goods;
receive an import/export classification request from a user for an import/export classification of a good of a cross-border commerce transaction;
respond to the import/export classification request by generating a computerized classification result by searching the database of import/export classifications for the plurality of goods using a two phase approach, the two phase approach comprising:
generate, during a first phase, a Harmonized System (HS) code for the good of the cross-border commerce transaction using a global classification model, the global classification model using a bespoke model with a static set of classes; and
refine, during a second phase, the Harmonized System (HS) code for the good of the cross-border commerce transaction to generate a Harmonized Tariff Schedule (HTS) code for the good of the cross-border commerce transaction using a locally specific model, the locally specific model using a zero-shot classification with a dynamic set of classes; and
provide a Harmonized Tariff Schedule code for the good of the cross-border commerce transaction to the user in response to the import/export classification request, the providing having increased Coherence and speed compared to using a full zero-shot classification with a one phase approach.

12. The apparatus of claim 11, wherein the Harmonized System (HS) code is a unique six-digit code of the good of the cross-border commerce transaction.

13. The apparatus of claim 11, wherein the Harmonized Tariff Schedule (HTS) code is an eight-digit code of the good of the cross-border commerce transaction.

14. The apparatus of claim 11, wherein the Harmonized Tariff Schedule (HTS) code is a ten-digit code of the good of the cross-border commerce transaction.

15. The apparatus of claim 11, wherein the Harmonized Tariff Schedule (HTS) code is a twelve-digit code of the good of the cross-border commerce transaction.

16. The apparatus of claim 11, wherein the maintaining the database comprises importing labeled classification data from a plurality of counties and training a Harmonized System (HS) classifier using the labeled classification data from the plurality of counties, the Harmonized System (HS) classifier being used for the generating, during the first phase, the Harmonized System (HS) code for the good of the cross-border commerce transaction.

17. The apparatus of claim 16, wherein the maintaining the database further comprises storing classified HS Codes using the Harmonized System (HS) classifier.

18. The apparatus of claim 11, wherein the maintaining the database comprises importing labeled classification data from a plurality of counties and training a Harmonized Tariff Schedule (HTS) refiner, the Harmonized Tariff Schedule (HTS) refiner being used during the second phase.

19. The apparatus of claim 18, wherein the maintaining the database further comprises storing classified HTS codes using the Harmonized Tariff Schedule (HTS) refiner.

20. A system, comprising:
one or more hardware processors configured by machine-readable instructions to:
maintain a database of import/export classifications for a plurality of goods comprising Harmonized System codes of the plurality of goods and Harmonized Tariff Schedule codes of the plurality of goods;
receive an import/export classification request from a user for an import/export classification of a good of a cross-border commerce transaction;
respond to the import/export classification request by generating a computerized classification result by searching the database of import/export classifications for the plurality of goods using a two phase approach, the two phase approach comprising:
generate, during a first phase, a Harmonized System (HS) code for the good of the cross-border commerce transaction using a global classification model, the global classification model using a bespoke model with a static set of classes; and
refine, during a second phase, the Harmonized System (HS) code for the good of the cross-border commerce transaction to generate a Harmonized Tariff Schedule (HTS) code for the good of the cross-border commerce transaction using a locally specific model, the locally specific model using a Natural Language Understanding model with a dynamic set of classes; and
provide a Harmonized Tariff Schedule code for the good of the cross-border commerce transaction to the user in response to the import/export classification request, the providing having increased Coherence and speed compared to using a full Natural Language Understanding model with a one phase approach.
